(19) United States
(12) Patent Application Publication
(10) Pub. No.: US 2026/0298745 A1
(43) Pub. Date: Oct. 1, 2026

(54) COMPONENT OF PRESSURE SENSOR AND PRESSURE SENSOR

(71) Applicant: TDK CORPORATION, Tokyo (JP)

(72) Inventor: Takashi AOYAGI, Tokyo (JP)

(73) Assignee: TDK CORPORATION, Tokyo (JP)

(21) Appl. No.: 19/630,610

(22) Filed: Mar. 27, 2026

(30) Foreign Application Priority Data
Mar. 28, 2025 (JP) 2025-057277

(51) Int. Cl. G01L 9/00

(52) U.S. Cl. CPC G01L 9/0052

(57) ABSTRACT

A metal component of a pressure sensor includes: a cylindrical side wall part having a cylindrical shape, and an upper wall part connected to one end of the cylindrical side wall part and forming an upper base, wherein an inner wall surface of the cylindrical side wall part is slanted and a distance between the inner wall surface and a central axis of the cylindrical side wall part becomes shorter towards the upper wall part, and an outer wall surface of the cylindrical side wall part is slanted and a distance between the outer wall surface and the central axis becomes shorter towards the upper wall part.

### CROSS-REFERENCE TO RELATED APPLICATIONS

This application claims priority to Japanese patent application No.2025-057277 filed on Mar. 28th 2025 which is incorporated herein by reference in its entirety.

### TECHNICAL FIELD

The present disclosure relates to a component of a pressure sensor and a pressure sensor using said component.

### BACKGROUND

As a pressure sensor, one which forms a detecting element made of a piezoresistive film on a surface of the component of the pressure sensor of cylindrical shape with a closed end called a stem has been proposed (such as Patent Document 1).

Also, as the component of the pressure sensor, desirably the fluid inside the component of the pressure sensor (inside a cavity of the component of the pressure sensor) can be replaced easily. For example, in the case that air bubbles are mixed in the fluid which is an object to be measured, and when such air bubbles remain near the upper wall part configuring a membrane, this could affect deformation behavior of the membrane in response to a fluid pressure which may cause a lowered measurement accuracy of the pressure sensor. Further, the deformation caused by the fluid pressure of the cylindrical side wall part, excluding the membrane, of the component of the pressure sensor may become large. This could impact the deformation behavior of the membrane in response to the fluid pressure and may lower the detection accuracy of the pressure sensor.

### PRIOR ART DOCUMENT

### PATENT DOCUMENT

[Patent Document 1] JP Patent Laid Open No.H11-37877

### SUMMARY

A metal component of a pressure sensor according to the present disclosure includes: a cylindrical side wall part having a cylindrical shape, and an upper wall part connected to one end of the cylindrical side wall part and forming an upper base, wherein an inner wall surface of the cylindrical side wall part is slanted and a distance between the inner wall surface and a central axis of the cylindrical side wall part becomes shorter towards the upper wall part, and an outer wall surface of the cylindrical side wall part is slanted and a distance between the outer wall surface and the central axis becomes shorter towards the upper wall part.

### BRIEF DESCRIPTION OF DRAWINGS

FIG. 1 is a cross-section figure of a component of a pressure sensor according to the first embodiment of the present disclosure.

FIG. 2 is a cross-section figure of the component of the pressure sensor according to the second embodiment of the present disclosure.

FIG. 3 is a cross-section figure of the component of the pressure sensor according to the third embodiment of the present disclosure.

FIG. 4 is a cross-section figure of the component of the pressure sensor according to the fourth embodiment of the present disclosure.

FIG. 5 is a figure showing a condition of the component of the pressure sensor shown in FIG. 4 being used.

FIG. 6A to FIG. 6C are conceptual figures showing examples of a method for manufacturing the component of the pressure sensor according to the present disclosure.

FIG. 7 is a cross-section figure of the component of the pressure sensor according to a modified example of the present disclosure.

### DETAILED DESCRIPTION

Below describes the present disclosure based on the embodiments shown in the figures.

### First Embodiment

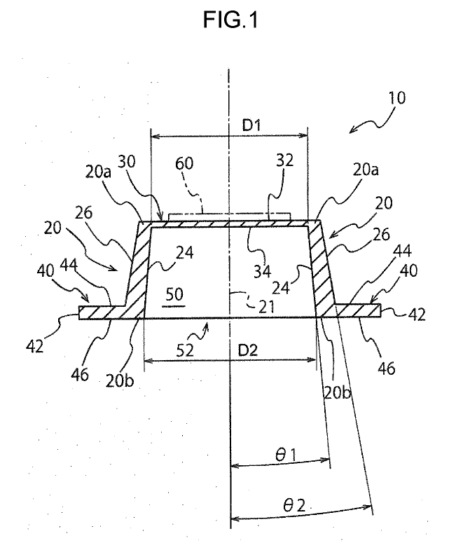

FIG. 1 is a cross-section figure of the component 10 of a pressure sensor according to the first embodiment of the present disclosure. As shown in FIG. 1, the component 10 of the pressure sensor includes a cylindrical side wall part 20 configuring a cylinder shape, an upper wall part 30 configuring an upper base, and a flange 40.

Note that, the flange 40 is a part primarily provided for fixing the component 10 of the pressure sensor to the other components. Thus, the flange 40 can change its shape according to the object which the component 10 of the pressure sensor is to be installed. Also, the component 10 of the pressure sensor according to the present disclosure includes the configuration which does not have the flange 40.

As shown in FIG. 1, a cavity 50 is formed inside the component 10 of the pressure sensor. Also, the pressure sensor using the component 10 of the pressure sensor includes the component 10 of the pressure sensor, and a pressure detection circuit 60 provided on the upper wall part 30 of the component 10 of the pressure sensor. Examples of the pressure detection circuit 60 include those including a piezoresistive film using a resistance change for detecting a modified amount of the upper wall part 30 configuring a membrane in the pressure sensor. For example, the piezoresistive film configuring the pressure detection circuit 60 is provided on an upper wall outer surface 32 which is an outer surface part of the upper wall part 30 of the metal component 10 of the pressure sensor. An insulation film (not shown in the figure) may be provided between the piezoresistive film and the upper wall outer surface 32.

A cylindrical side wall part 20 shown in FIG. 1 is a circular cylinder-like shape; however, the cylindrical side wall part 20 is not limited to a circular cylinder-like shape, and it may be an oval cylinder shape, or a polygonal prism shape. In FIG. 1, a direction of a central axis 21 (a central axis of the cylinder) of the cylindrical side wall part 20 matches the vertical direction.

In the description of the component 10 of the pressure sensor, a direction toward the upper wall part 30 from the flange 40 along the central axis 21 is deemed an upward direction, and a direction toward the flange 40 from the upper wall part 30 along the central axis 21 is deemed a downward direction. Note that, the pressure sensor using the component 10 of the pressure sensor may be installed in any direction with respect to the other components.

As shown in FIG. 1, an inner wall surface 24 which is an inner surface of the cylindrical side wall part 20 configures the side wall of the cavity 50. Also, an outer wall surface 26 which is an outer surface of the cylindrical side wall part 20 is one of the surfaces exposed to the outside of the component 10 of the pressure sensor; and, the outer wall surface 26 connects to the upper wall outer surface 32 including the outer surface of the upper wall part 30 and connects to a flange upper surface 44 of the flange 40.

The upper wall part 30 connects to a side wall upper end 20a which is one end of the cylindrical side wall part 20, and the upper wall part 30 forms an upper base. Note that, the outer wall surface 26 and the upper wall outer surface 32 may be directly connected. Alternatively, the outer wall surface 26 and the upper wall outer surface 32 may be indirectly connected via a connecting surface having a chamfer-shaped or a R-shaped. Further, the outer wall surface 26 and the flange upper surface 44 may be directly connected. Alternatively, the outer wall surface 26 and the flange upper surface 44 may be indirectly connected via a connecting surface having a chamfer-shaped or a R-shaped. As mentioned in above, the component 10 of the pressure sensor is made of a metal material. In the case that the component 10 is used for the pressure sensor, the upper wall part 30 functions a membrane which deforms in response to the pressure change inside the cavity 50.

An upper wall inner surface 34 which is the inner surface of the upper wall part 30 configures the upper wall of the cavity 50. Further, when the component 10 of the pressure sensor is used for the pressure sensor, the upper wall inner surface 34 functions as a receiving surface of the pressure of the fluid inside the cavity 50. Also, the pressure detection circuit 60 is provided on the upper wall outer surface 32 of the outer surface part of the upper wall part 30. Note that, the inner wall surface 24 and the upper wall inner surface 34 may be directly connected. Alternatively, the inner wall surface 24 and the upper wall inner surface 34 may be indirectly connected via a connecting surface having a chamfer-shaped or a R-shaped.

As shown in FIG. 1, the flange 40 connects to a side wall lower end 20b which is the other end of the cylindrical side wall part 20. The flange 40 protrudes outwards from the side wall lower end 20b in a radial direction of the cylindrical side wall part 20. The radial direction of the cylindrical side wall part 20 is perpendicular to the central axis 21.

The flange 40 has a ring-like shape, and includes a flange upper surface 44 connecting to the outer wall surface 26 of the cylindrical side wall part 20, a part of a lower surface 46 in an outer circumference side connecting to the inner wall surface 24 of the cylindrical side wall part 20, and a flange outer lateral surface 42 connecting to the flange upper surface 44 and the lower surface 46. The flange upper surface 44 is the surface facing up, and the lower surface 46 is the surface facing down. The inner wall surface 24 and the lower surface 46 may be directly connected. Alternatively, the inner wall surface 24 and the lower surface 46 may be indirectly connected via a connecting surface having a chamfer-shaped or a R-shaped. Further, the lower surface 46 and the flange outer lateral surface 42 may be directly connected. Alternatively, the lower surface 46 and the flange outer lateral surface 42 may be indirectly connected via a connecting surface having a chamfered shaped or a R-shape. Also, the flange upper surface 44 and the flange outer lateral surface 42 may be directly connected. Alternatively, the flange upper surface 44 and the flange outer lateral surface 42 may be indirectly connected via a connecting surface having a chamfer-shaped or a R-shaped.

As shown in FIG. 1, at the inside of the component 10 of the pressure sensor, the cavity 50, which is surrounded by the inner wall surface 24 and the upper wall inner surface 34, is formed. The upper wall inner surface 34 which is the upper base of the cavity 50 has an approximate circular shape. Also, the cavity 50 is opened at the lower side, and the lower surface 46 surrounds a lower side opening 52 of the cavity 50. As discussed later, the cavity 50 has a truncated cone shape in which the inner wall surface 24 configuring the lateral surface of the cavity 50 is slanted with respect to the central axis 21 of the cylindrical side wall part 20.

As shown in FIG. 1, the inner wall surface 24 configuring the lateral wall of the cavity 50 is slanted with respect to the central axis 21 of the cylindrical side wall part 20. That is, the inner wall surface 24 of the cylindrical side wall part 20 is slanted, and the distance between the inner wall surface and the central axis 21 of the cylindrical side wall part 20 becomes shorter as approaching closer to the upper wall part 30. Thus, a diameter D2 of the lower side opening 52 which is the opening of the cavity 50 is larger than a diameter D1 of the upper wall inner surface 34 of the upper base, and the lower side opening 52 has a larger area than the upper wall inner surface 34.

As such, because the inner wall surface 24 is slanted, the fluid inside the cavity 50 of the component 10 of the pressure sensor can be replaced easily. When the component of the pressure sensor is used for the pressure sensor, such configuration makes it possible to effectively prevent the air bubbles mixed in the fluid as an object to be measured from remaining near the upper wall inner surface 34. A slanted angle θ1 which is an angle of the inner wall surface 24 with respect to the central axis 21 is not particularly limited, and it may be between 1 to 10°.

Also, the outer wall surface 26 of the cylindrical side wall part 20 is slanted with respect to the central axis 21 in the same direction as the inner wall surface 24 is slanted. That is, the outer wall surface 26 of the cylindrical side wall part 20 is slanted, and the distance between the outer wall surface 26 and the central axis 21 of the cylindrical side wall part 20 becomes shorter as approaching closer to the upper wall part 30. If the outer wall surface 26 is parallel with respect to the central axis 21, the wall thickness of the cylindrical side wall part 20 would become thinner towards the lower side (at the side of the flange 40 or at the side of the lower side opening 52) since the inner wall surface 24 is slanted. However, the outer wall surface 26 of the cylindrical side wall part 20 is slanted with respect to the central axis 21 in the same direction as the inner wall surface 24 is slanted; thus, this configuration prevents the wall thickness of the cylindrical side wall part 20 from thinning down towards the lower side.

A slanted angle θ2 which is an angle of the outer wall surface 26 with respect to the central axis 21 is not particularly limited, and it may be between 1 to 15°. Also, in the component 10 of the pressure sensor shown in FIG. 1, the slanted angle θ2 of the outer wall surface 26 with respect to the central axis 21 is larger than the slanted angle θ1 of the inner wall surface 24 with respect to the central axis 21. In other words, the thickness of the cylindrical side wall part 20 in a radial direction becomes thicker towards the lower side. In such component 10 of the pressure sensor, the wall thickness of the cylindrical side wall part 20 becomes thicker towards the lower side; thus, the modified part of the component 10 of the pressure sensor caused by the pressure of the fluid as an object to be measured inside the cavity 50 can be effectively concentrated to the upper wall part 30 which is a membrane. Therefore, the pressure sensor using such component 10 of the pressure sensor can achieve an improved accuracy for measuring the pressure, since the upper wall part 30 configuring the membrane undergoes appropriate modification in response to the pressure of the fluid as an object to be measured.

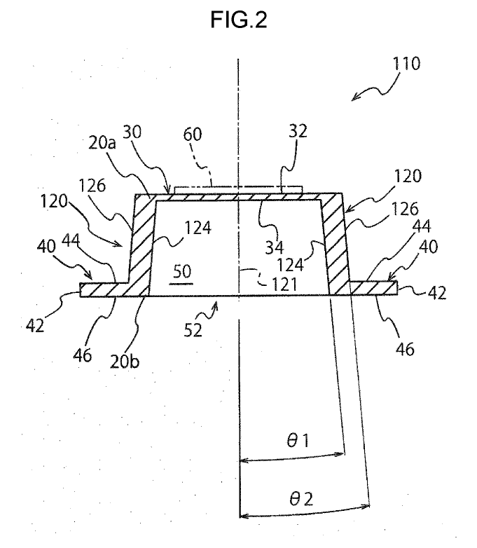

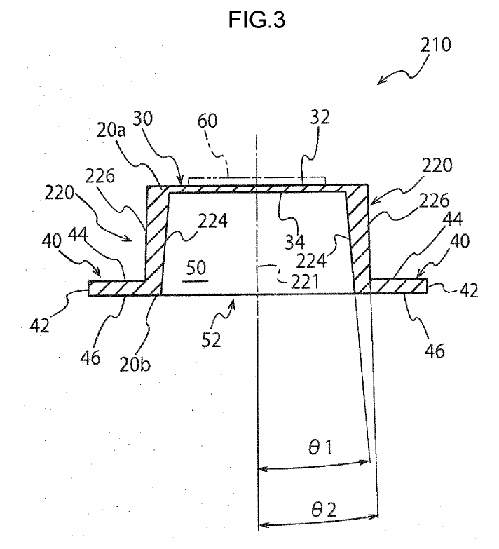

A difference between the slanted angle θ2 which is an angle of the outer wall surface 26 with respect to the central axis 21 and the slanted angle θ1 of the inner wall surface 24 with respect to the central axis 21 is not particularly limited. For example, the slanted angle θ2 is larger than the slanted angle θ1 by 1 to 5°. Note that, as mentioned later, the slanted angle θ2 of the outer wall surface 26 with respect to the central axis 21 may be the same as the slanted angle θ1 of the inner wall surface 24 with respect to the central axis 21 (see FIG. 2), or may be smaller than the slanted angle θ1 of the inner wall surface 24 with respect to the central axis 21 (see FIG. 3). Also, a thickness of the upper wall part 30 is not particularly limited, and it may be between 50 to 1000 μm. Also, a thickness (average thickness) of the upper wall part 20 is not particularly limited, and it may be between 0.5 to 5 mm.

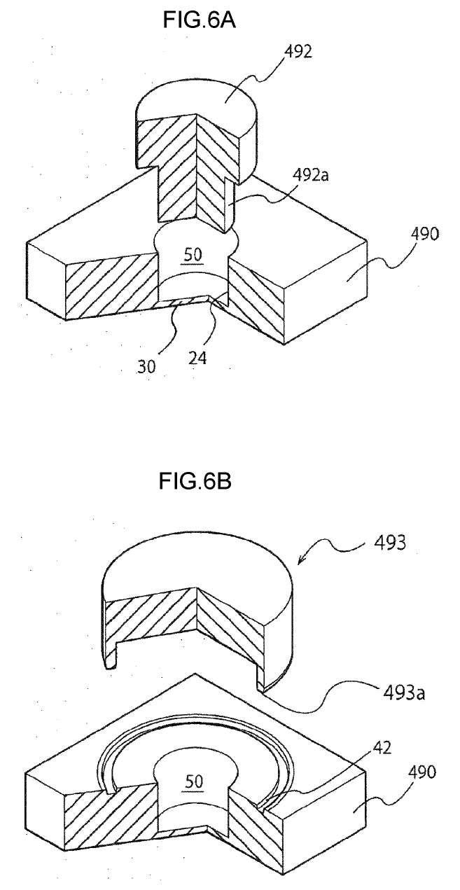

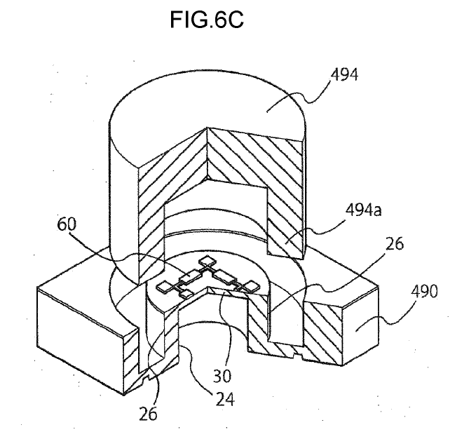

The component 10 of the pressure sensor shown in FIG. 1 can be manufactured, for example, by using a press processing or a grind processing to a metal material such as stainless steel. Also, the component 10 of the pressure sensor may be manufactured using a die sinking electrical discharge machining process as discussed later (see FIG. 6A to FIG. 6C).

The component 10 of the pressure sensor shown in FIG. 1 is slanted and the inner wall surface 24 approaches closer to the central axis 21 towards the upper wall part 30, thus, the fluid inside the component 10 of the pressure sensor can be replaced easily. Also, the outer wall surface 26 is slanted and approaches closer to the central axis 21 towards the upper wall part 30. Such configuration makes it possible to prevent the wall thickness from becoming thinner at the side wall lower end 20b of the cylindrical side wall part 20, and also makes it possible to reduce the modification of the cylindrical side wall part 20 caused by the fluid pressure inside the cavity 50. The pressure sensor using such component 10 of the pressure sensor can reduce the modification caused by the fluid pressure of the cylindrical side wall part 20, and also effectively prevents the air bubbles from remaining near the upper wall inner surface 34. Thereby, the measuring accuracy of the pressure can be improved.

### Second Embodiment

FIG. 2 is a cross-section figure of a component 110 of a pressure sensor according to the second embodiment of the present disclosure. The component 110 of the pressure sensor is different from the component 10 of the pressure sensor shown in FIG. 1 since a slanted angle θ1 of an inner wall surface 124 of a cylindrical side wall part 120 with respect to a central axis 121 and a slanted angle θ2 of an outer wall surface 126 with respect to the central axis 121 are the same. Other than the slanted angles of the inner wall surface 124 and the outer wall surface 126 of the cylindrical side wall part 120, the component 110 of the pressure sensor is similar to the component 10 of the pressure sensor shown in FIG. 1. The component 110 of the pressure sensor is discussed focusing primarily on the differences from the component 110 of the pressure sensor; and, the descriptions regarding the common configurations with the component 10 of the pressure sensor are skipped.

As shown in FIG. 2, similarly to the component 10 of the pressure sensor shown in FIG. 1, the component 110 of the pressure sensor includes the cylindrical side wall part 120 having a cylinder shape, the upper wall part 30 configuring an upper base, and the flange 40. Also, at the inside of the component 110 of the pressure sensor, a cavity 50 which is surrounded by the inner wall surface 124 and the upper wall inner surface 34 is formed.

As shown in FIG. 2, the inner wall surface 124 configuring the lateral wall of the cavity 50 is slanted with respect to the central axis 121 of the cylindrical side wall part 120. That is, the inner wall surface 124 of the cylindrical side wall part 120 is slanted, and the distance between the inner wall surface 124 and the central axis 121 of the cylindrical side wall part 120 becomes shorter as approaching closer to the upper wall part 30.

Also, the outer wall surface 126 of the cylindrical side wall part 120 is slanted with respect to the central axis 121 in the same direction as the inner wall surface 124 is slanted. That is, the outer wall surface 126 of the cylindrical side wall part 120 is slanted, and the distance between the outer wall surface 126 and the central axis 121 of the cylindrical side wall part 120 becomes shorter as approaching closer to the upper wall part 30.

As shown in FIG. 2, the slanted angle θ2 of the outer wall surface 126 with respect to the central axis 121 is the same as the slanted angle θ1 of the inner wall surface 124 with respect to the central axis 121. In the component 110 of the pressure sensor, a thickness of the cylindrical side wall part 120 is consistent along a height direction. Therefore, if the average thickness is the same, the cylindrical side wall part 120 of the component 110 of the pressure sensor having a consistent thickness exhibits an enhanced pressure resistance compared to other components of the pressure sensor which the thickness changes along the height direction.

Regarding the configurations of the component 110 of the pressure sensor which are common with the component 10 of the pressure sensor shown in FIG. 1, the component 110 of the pressure sensor shown in FIG. 2 exhibits the similar effects as the component 10 of the pressure sensor. Also, the pressure sensor using such component 110 of the pressure sensor can reduce the modification caused by the fluid pressure of the cylindrical side wall part 120, and also effectively prevents the air bubbles from remaining near the upper wall inner surface 34. Thereby, the measuring accuracy of the pressure can be improved.

### Third Embodiment

FIG. 3 is a cross-section figure of a component 210 of a pressure sensor according to the third embodiment of the present disclosure. The component 210 of the pressure sensor is different from the component 10 of the pressure sensor shown in FIG. 1 since a slanted angle θ1 of an inner wall surface 224 of a cylindrical side wall part 220 with respect to a central axis 221 is larger than a slanted angle θ2 of the outer wall surface 226 with respect to the central axis 221. Other than the slanted angles of the inner wall surface 224 and the outer wall surface 226 of the cylindrical side wall part 220, the component 210 of the pressure sensor is similar to the component 10 of the pressure sensor shown in FIG. 1. The component 210 of the pressure sensor is discussed focusing primarily on the differences from the component 10 of the pressure sensor; and, the descriptions regarding the common configurations with the component 10 of the pressure sensor are skipped.

As shown in FIG. 3, similarly to the component 10 of the pressure sensor shown in FIG. 1, the component 210 of the pressure sensor includes the cylindrical side wall part 220 having a cylinder shape, the upper wall part 30 configuring an upper base, and the flange 40. Also, at the inside of the component 210 of the pressure sensor, a cavity 50, which is surrounded by the inner wall surface 224 and the upper wall inner surface 34, is formed.

As shown in FIG. 3, the inner wall surface 224 configuring the lateral wall of the cavity 50 is slanted with respect to the central axis 221 of the cylindrical side wall part 220. That is, the inner wall surface 224 of the cylindrical side wall part 220 is slanted, and the distance between the inner wall surface 224 and the central axis 221 of the cylindrical side wall part 220 becomes shorter as approaching closer to the upper wall part 30.

Also, the outer wall surface 226 of the cylindrical side wall part 220 is slanted with respect to the central axis 221 in the same direction as the inner wall surface 224 is slanted. That is, the outer wall surface 226 of the cylindrical side wall part 220 is slanted, and the distance between the outer wall surface 226 and the central axis 221 of the cylindrical side wall part 220 becomes shorter as approaching closer to the upper wall part 30.

As shown in FIG. 3, the slanted angle θ1 of the inner wall surface 224 with respect to the central axis 221 is larger than the slanted angle θ2 of the outer wall surface 226 with respect to the central axis 221. Such component 210 of the pressure sensor has a larger angle of the slanted angle θ1, and the fluid inside the cavity 50 of component 210 of the pressure sensor can be replaced even more easily.

Regarding the configurations of the component 210 of the pressure sensor which are common with the component 10 of the pressure sensor shown in FIG. 1, the component 210 of the pressure sensor shown in FIG. 3 exhibits the similar effects as the component 10 of the pressure sensor. Also, the pressure sensor using such component 210 of the pressure sensor can reduce the modification caused by the fluid pressure of the cylindrical side wall part 220, and also effectively prevents the air bubbles from remaining near the upper wall inner surface 34. Thereby, the measuring accuracy of the pressure can be improved.

### Fourth Embodiment

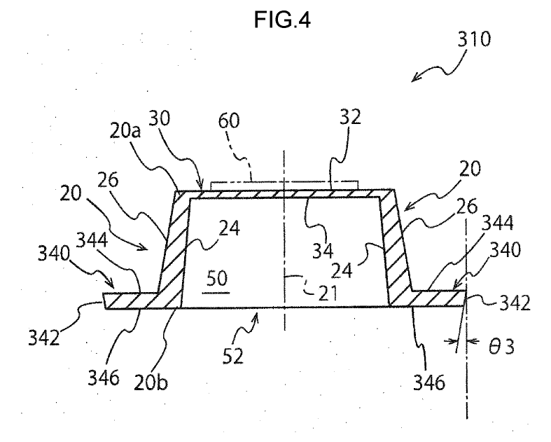

FIG. 4 is a cross-section figure of a component 310 of a pressure sensor according to the fourth embodiment of the present disclosure. The component 310 of the pressure sensor is different from the component 10 of the pressure sensor shown in FIG. 1 since a flange outer lateral surface 342 of a flange 340 is slanted with respect to the central axis 21. Other than the flange 340, the component 310 of the pressure sensor is similar to the component 10 of the pressure sensor shown in FIG. 1. The component 310 of the pressure sensor is discussed focusing primarily on the differences from the component 10 of the pressure sensor; and, the descriptions regarding the common configurations with the component 10 of the pressure sensor are skipped.

As shown in FIG. 4, similarly to the component 10 of the pressure sensor shown in FIG. 1, the component 310 of the pressure sensor includes the cylindrical side wall part 20 having a cylinder shape, the upper wall part 30 configuring an upper base, and the flange 340. Also, at the inside of the component 310 of the pressure sensor, a cavity 50, which is surrounded by the inner wall surface 24 and the upper wall inner surface 34, is formed.

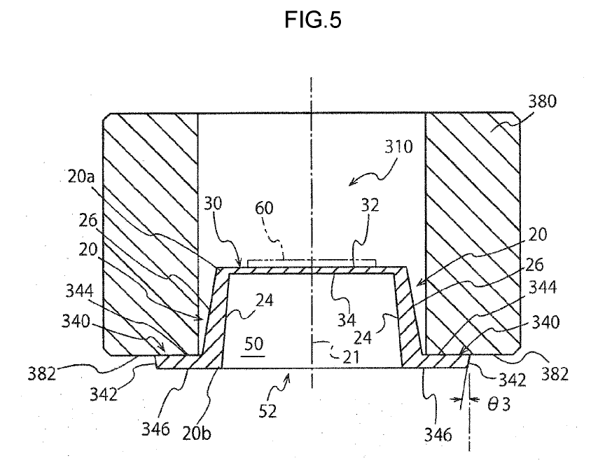

As understood from comparison between FIG. 1 and FIG. 4, the flange outer lateral surface 42 of the component 10 of the pressure sensor shown in FIG. 1 is parallel to the central axis 21; whereas the flange outer lateral surface 342 of the component 310 of the pressure sensor shown in FIG. 5 is slanted with respect to the central axis 21. That is, in the component 310 of the pressure sensor, the flange outer lateral surface 342 of the flange 340 is slanted and a distance between the flange outer lateral surface 342 and the central axis 21 becomes longer towards upper side.

A slanted angle θ3 which is an angle of the flange outer lateral surface 342 with respect to the central axis is not particularly limited, and it may be between 1 to 15°.

FIG. 5 is a cross-section figure showing a condition at which the pressure sensor using the component 310 shown in FIG. 4 is fixed to an installation structure 380 which is another component. As shown in FIG. 5, the pressure sensor using the component 310 is provided on an instillation surface 382 of the installation structure 380 by bonding a flange upper surface 344 using a resistance welding, etc.

As shown in FIG. 5, in the component 310 of the pressure sensor, the flange outer lateral surface 342 is slanted, and a distance between the flange outer lateral surface 342 and the central axis 21 becomes longer towards the upper side. Thus, in the case that the component 310 of the pressure sensor is used by bonding the upper surface of the flange 340 to the installation surface 382, when a force in a lateral direction is applied from the outside to the flange outer lateral surface 342, the component 310 of the pressure sensor can receive the force in a direction pressing towards the installation surface 382 from the flange outer lateral surface 342. Therefore, the pressure sensor using the component 310 has a higher reliability of the bonding part against the other components.

Furthermore, regarding the configurations of the component 310 of the pressure sensor which are common with the component 10 of the pressure sensor shown in FIG. 1, the component 310 of the pressure sensor shown in FIG. 4 and FIG. 5 exhibits the similar effects as the component 10 of the pressure sensor.

Herein above, the component of the pressure sensor according to the present disclosure is described using the embodiments. However, the component of the pressure sensor according to the present disclosure is not limited to the above-mentioned embodiments, and many other embodiments and modification examples are included in the present disclosure. For example, the thicknesses of the cylindrical side wall part 20, the upper wall part 30, and the flange 40 may be changed according to the measuring condition of the pressure sensor. Also, for example, regarding the shape of the cylindrical side wall part 20 of the component 310 of the pressure sensor according to the fourth embodiment, the shape of the cylindrical side wall part 120 according to the second embodiment or the shape of the cylindrical side wall part 220 according to the third embodiment may be employed.

FIG. 6A to FIG. 6C are the conceptual figures showing an example of the method for manufacturing the above-mentioned component 10 of the pressure sensor. As shown in FIG. 6A to FIG. 6C, regarding the component 10 of the pressure sensor, the inner wall surface 24 and the outer wall surface 26 of the cylindrical side wall part 20, the flange outer lateral surface 42, etc., may be formed by a die sinking electrical discharge machining process using an electrode 492, an electrode 493, and an electrode 494. In the die sinking electrical discharge machining process, the shapes which correspond to a protrusion 492a of the electrode 492 shown in FIG. 6A, a protrusion 493a of the electrode 493 shown in FIG. 6B, and a protrusion 494a of the electrode 494 shown in FIG. 6C are formed to a metal plate 490 as a raw material. Thereby, the shapes of the inner wall surface 24, the flange outer lateral surface 42, and the outer wall surface 26 are formed.

According to the manufacturing method for forming the shapes of the inner wall surface 24 and the outer wall surface 26 of the cylindrical side wall part 20 using the die sinking electrical discharge machining process, the slanted angle θ1 of the inner wall surface 24 and the slanted angle θ2 of the outer wall surface 26 which are shown in FIG. 1 can be set to any angle independently. Also, according to the manufacturing method for forming the shapes of the flange outer lateral surface 42 by the die sinking electrical discharge machining process, the slanted angle θ3 of the flange outer lateral surface 42 and the slanted angle θ2 of the outer wall surface 26 which are shown in FIG. 4 can be set to any angle independently. Also, according to the manufacturing method which uses the die sinking electrical discharge machining process, compared to the case of manufacturing the component of the pressure sensor using a pressing process or a grinding process, it is possible to reduce the influence of vibrations, impacts, heats, etc., which are generated during the processing. Hence, the deformation such as warpage of the component of the pressure sensor can be prevented. Note that, in FIG. 6A to FIG. 6C, the shape of the component 10 of the pressure sensor is simplified.

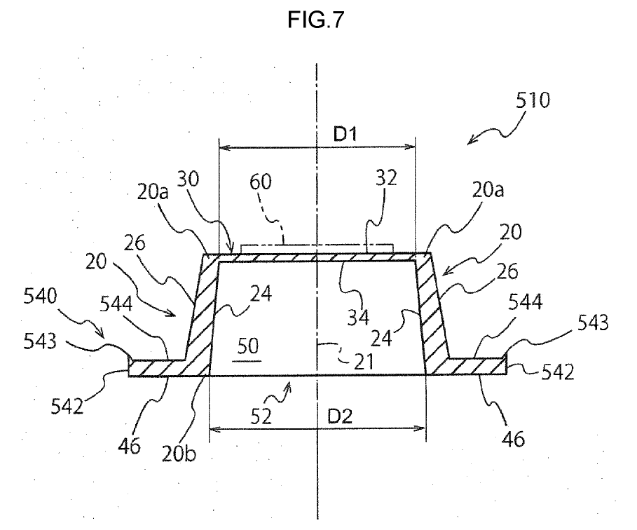

FIG. 7 is a cross-section figure of a component 510 of a pressure sensor according to a modified example of the present disclosure. The component 510 of the pressure sensor includes a flange 530, and a flange outer edge protrusion 543 which is projecting upwards at the outer edge of the flange upper surface 544. The flange outer edge protrusion 543 is formed in a ring-like form around the central axis 21. As shown in FIG. 7, the flange upper surface 544 and a flange outer lateral surface 542 may be connected via the flange outer edge protrusion 543. As shown in FIG. 5, regarding the component 510 of the pressure sensor, the flange outer edge protrusion 543 easily melts when the flange upper surface 544 is bonded to the installation surface 382 of the installation structure 380 using resistance welding. Thus, the component 510 of the pressure sensor can be fixed to the installation surface 382 even more firmly. Note that, besides the fact that the component 510 of the pressure sensor includes the flange outer edge protrusion 543, regarding the configurations of the component 510 of the pressure sensor which are common with the component 10 of the pressure sensor shown in FIG. 1, the component 510 of the pressure sensor exhibits the similar effects as the component 10 of the pressure sensor. Also, the component 310 of the pressure sensor according to the fourth embodiment may have the flange outer edge protrusion similarly to the component 510 of the pressure sensor according to the modified example.

### Notes

As is understood from the above description, the present specification discloses the following.

[1] A metal component of a pressure sensor, comprising:

a cylindrical side wall part having a cylindrical shape, and

an upper wall part connected to one end of the cylindrical side wall part and forming an upper base,

wherein

an inner wall surface of the cylindrical side wall part is slanted and a distance between the inner wall surface and a central axis of the cylindrical side wall part becomes shorter towards the upper wall part, and

an outer wall surface of the cylindrical side wall part is slanted and a distance between the outer wall surface and the central axis becomes shorter towards the upper wall part.

[2] The component of the pressure sensor according to [1], wherein a slanted angle of the outer wall surface with respect to the central axis is larger than a slanted angle of the inner wall surface with respect to the central axis.

[3] The component of the pressure sensor according to [1], comprising a flange connected to an other end of the cylindrical side wall part and protrudes out from the cylindrical side wall part in a radial direction of the cylindrical side wall part; and

an outer lateral surface of the flange is slanted and a distance between the outer lateral surface and the central axis becomes longer towards an upper side.

[4] The component of the pressure sensor according to [2], comprising a flange connected to an other end of the cylindrical side wall part and protrudes out from the cylindrical side wall part in a radial direction of the cylindrical side wall part; and

an outer lateral surface of the flange is slanted and a distance between the outer lateral surface and the central axis becomes longer towards an upper side.

[5] A pressure sensor comprising:

the component of the pressure sensor according to [1], and

a piezoresistive film provided on the upper wall part of the component of the pressure sensor.

[6] A pressure sensor comprising:

the component of the pressure sensor according to [2], and

a piezoresistive film provided on the upper wall part of the component of the pressure sensor.

[7] A pressure sensor comprising:

the component of the pressure sensor according to [3], and

a piezoresistive film provided on the upper wall part of the component of the pressure sensor.

[8] A pressure sensor comprising:

the component of the pressure sensor according to [4], and

a piezoresistive film provided on the upper wall part of the component of the pressure sensor.

### REFERENCE SIGNS LIST

10, 110, 210, 310, 410, 510...Component of pressure sensor

20, 120, 220…Cylindrical side wall part

20a...Side wall upper end

20b...Side wall lower end

21, 121, 221...Central axis

24, 124, 224... Inner wall surface

θ1, θ2...Slanted angle

26, 126, 226... Outer wall surface

30... Upper wall part

32... Upper wall outer surface

34... Upper wall inner surface

40, 340, 540...Flange upper

42, 342, 542... Flange outer lateral surface

44, 344, 544...Flange upper surface

46, 346...Lower surface

543…Flange outer edge protrusion

50...Cavity

52...Lower side opening

60...Pressure detection circuit

What is claimed is:

1. A metal component of a pressure sensor, comprising:
a cylindrical side wall part having a cylindrical shape, and
an upper wall part connected to one end of the cylindrical side wall part and forming an upper base,
wherein
an inner wall surface of the cylindrical side wall part is slanted and a distance between the inner wall surface and a central axis of the cylindrical side wall part becomes shorter towards the upper wall part, and
an outer wall surface of the cylindrical side wall part is slanted and a distance between the outer wall surface and the central axis becomes shorter towards the upper wall part.

2. The component of the pressure sensor according to claim 1, wherein a slanted angle of the outer wall surface with respect to the central axis is larger than a slanted angle of the inner wall surface with respect to the central axis.

3. The component of the pressure sensor according to claim 1, comprising a flange connected to an other end of the cylindrical side wall part and protrudes out from the cylindrical side wall part in a radial direction of the cylindrical side wall part; and
an outer lateral surface of the flange is slanted and a distance between the outer lateral surface and the central axis becomes longer towards an upper side.

4. The component of the pressure sensor according to claim 2, comprising a flange connected to an other end of the cylindrical side wall part and protrudes out from the cylindrical side wall part in a radial direction of the cylindrical side wall part; and
an outer lateral surface of the flange is slanted and a distance between the outer lateral surface and the central axis becomes longer towards an upper side.

5. A pressure sensor comprising:
the component of the pressure sensor according to claim 1, and
a piezoresistive film provided on the upper wall part of the component of the pressure sensor.

6. A pressure sensor comprising:
the component of the pressure sensor according to claim 2, and
a piezoresistive film provided on the upper wall part of the component of the pressure sensor.

7. A pressure sensor comprising:
the component of the pressure sensor according to claim 3, and
a piezoresistive film provided on the upper wall part of the component of the pressure sensor.

8. A pressure sensor comprising:
the component of the pressure sensor according to claim 4, and
a piezoresistive film provided on the upper wall part of the component of the pressure sensor.
